(19) United States
(12) Patent Application Publication
(10) Pub. No.: US 2021/0256840 A1
(43) Pub. Date: Aug. 19, 2021

(54) A METHOD AND A CONTROL UNIT FOR IDENTIFYING AN ACCIDENT SITUATION BETWEEN AT LEAST TWO VEHICLES

(71) Applicant: VOLVO CONSTRUCTION EQUIPMENT AB, Eskilstuna (SE)

(72) Inventors: Calle SKILLSÄTER, Torshälla (SE); Andreas NORRMAN, Arboga (SE)

(21) Appl. No.: 17/251,560

(22) PCT Filed: Jun. 15, 2018
(86) PCT No.: PCT/EP2018/065960

§ 371 Date: Dec. 11, 2020

(51) Int. Cl. G08G 1/01; G08G 1/052; H04W 4/40; G08G 1/017

(52) U.S. Cl. CPC G08G 1/0133; G08G 1/0112; G08G 1/017; H04W 4/40; G08G 1/052

(57) ABSTRACT

The disclosure relates to a method for identifying an accident situation between at least two vehicles, wherein the method comprises the steps of:
receiving data relating to the at least two vehicles, which data comprises information indicative of geographical position and at least one of velocity and acceleration of each one of the at least two vehicles; and
determining, by using said received data, that the accident situation has occurred between the at least two vehicles when a deceleration of at least one of the at least two vehicles exceeds a predetermined threshold value at the substantially same point in time at which the at least two vehicles are located at the substantially same geographical position. Moreover, the disclosure relates to a control unit and a vehicle.

### TECHNICAL FIELD

The present invention relates to a method for identifying an accident situation between at least two vehicles. Moreover, the present invention relates to a control unit, a vehicle, a computer program and a computer readable medium.

The invention can be applied in heavy-duty vehicles, such as trucks, buses and construction equipment. Although the invention mainly will be described with respect to construction equipment, the invention is not restricted to this particular vehicle, but may also be used in other vehicles.

### BACKGROUND

Vehicles generally operate in environments together with other vehicles. This includes public traffic networks, but also confined areas, such as construction areas, mining areas, factory areas, logistics centrals etc.

For example, construction equipment vehicles on a work site are generally involved in potentially dangerous situations on a daily basis. In order to reduce the risk that dangerous situations occur, it is known to make use of different solutions. This may for example be to equip vehicles with brake lights which are configured to issue emergency brake light warnings during rapid braking. Another example is to equip vehicles with loudspeakers which issue warning signals, in the form of sounds, during reversing. By the aforementioned examples, the risk of accidents may be reduced.

Moreover, in recent years it has also become known to provide communication between vehicles and between vehicles and any other entity, where information relating to a vehicle may be transmitted and used for increasing safety. In this respect, so called V2X (vehicle-to-everything) communication systems have been developed, which may be defined as communication systems configured for passing of information from a vehicle to any other entity that may affect the vehicle. For example, such communication systems may be used in the following manner: if one vehicle is braking rapidly, the braking vehicle may wirelessly transmit information about this to following vehicles located behind the braking vehicle. The received information may be used so that the following vehicles more rapidly may initiate braking, and the risk of collisions may therefore be reduced. This may be beneficial in dense traffic situations, such as in traffic queues. There is however a strive to further increase the safety when operating a vehicle.

### SUMMARY

An object of the present invention is to provide an improved method which improves safety for vehicles and which increases awareness of potentially dangerous situations.

The object is achieved by the subject matter defined in the independent claims. Advantageous embodiments may be found in the dependent claims and in the accompanying description and drawings.

According to a first aspect, the object is provided by a method for identifying an accident situation between at least two vehicles, wherein the method comprises the steps of:
receiving data relating to the at least two vehicles, which data comprises information indicative of geographical position and at least one of velocity and acceleration of each one of the at least two vehicles; and
determining, by using the received data, that the accident situation has occurred between the at least two vehicles when a deceleration of at least one of the at least two vehicles exceeds a predetermined threshold value at the substantially same point in time at which the at least two vehicles are located at the substantially same geographical position.

By the provision of the method as disclosed herein, improved safety and increased awareness of potentially dangerous situations may be provided. More particularly, it has been found that by receiving broadcasted information relating to speed and/or acceleration and geographical position of each one of at least two vehicles, it is possible to identify an accident situation between the at least two vehicles. Hence, by using the received data and processing the data, the accident situation may be identified, and this knowledge may be used for awareness and increased safety. Improved safety may for example be provided by the fact that the accident situation may be identified at an early stage in time, thereby being able to report the accident and request for assistance in short notice. Increased awareness may for example be provided by gaining knowledge about the accident situation, which knowledge for example may be used by another vehicle for avoiding the location where the accident has occurred. Moreover, as another non-limiting example, if the accident has occurred on a work site and the vehicles of the accident are working machines, the increased awareness may be used for making fast decisions on how to handle the situation, thereby increasing working efficiency on the work site. For example, with the gained knowledge about the accident, a back office may realize that the collided vehicles are out of operation and therefore request other vehicles to replace the collided vehicles to take over the assignments/tasks of the collided vehicles.

A deceleration of at least one of the at least two vehicles which are part of the accident situation may be determined by using speed and/or acceleration data of at least one of the at least two vehicles. Hence, the deceleration may be identified when the received acceleration data value exceeds a certain threshold value. Moreover, the deceleration may be identified when a change in speed over time is recognized which exceeds a certain threshold value. As will be understood by the skilled person, the threshold value may be set such that it reflects the impact force of an accident, and this value may be set differently depending on several factors, such as type of vehicles, type of situations etc. Moreover, deceleration may be defined as negative acceleration, i.e. a speed decrease.

The expression “substantially same point in time” as used herein means that the at least two criterias, deceleration and at which the at least two vehicles are located at the substantially same geographical position, occurs at least within a certain time interval from each other, such as within 5, 4, 3, 2, 1 second(s) or less. Substantial same point in time is thus within a predetermined threshold period.

The expression “substantially same geographical position” as used herein means that the at least two vehicles are located, or determined to be located, a certain distance or less from each other, such as 20, 15, 10, 9, 8, 7, 6, 5, 4, 3, 2 or 1 meter(s) or less from each other. Purely by way of example, “substantially same geographical position” may thus mean that centre points of the at least two vehicles are located within a predetermined range, such as within 20, 15, 10, 9, 8, 7, 6, 5, 4, 3, 2 or 1 meter(s) or less. As will be understood by the skilled person, techniques which may provide geographical positions of objects may have certain error margins. Purely by way of example, a GPS (global positioning system) may provide an error margin of up to 8 meters. Moreover, other errors of the received data relating to geographical position of each respective vehicle may also be considered. For example, determined relative geographical position between the at least two vehicles may differ depending on for example the placement of GPS sensors on the respective vehicles.

The expression “accident situation” as used herein means that the at least two vehicles have collided with, or crashed into, each other, i.e. they have hit each other, or at least the received data indicates that the at least two vehicles have collided with each other.

Optionally, the step of determining that the accident situation has occurred between the at least two vehicles may comprise: determining, by using the received data, that the accident situation has occurred between the at least two vehicles when a deceleration of each one of the at least two vehicles exceeds a predetermined threshold value at the substantially same point in time at which the at least two vehicles are located at the substantially same geographical position. Thereby, the likelihood that the accident situation actually has occurred may be increased. Still optionally, the step of determining that the accident situation has occurred between the at least two vehicles may comprise: determining, by using the received data, that the accident situation has occurred between the at least two vehicles when a deceleration of one of the at least two vehicles exceeds the predetermined threshold value and when an acceleration of the at least other one of the at least two vehicles exceeds a second threshold value at the substantially same point in time at which the at least two vehicles are located at the substantially same geographical position. More particularly, an accident situation may be identified when one vehicle collides with another vehicle, such as a side impact collision, resulting in an acceleration of the vehicle which is hit on the side. Hence, the deceleration and/or the acceleration may be in any direction with respect to the vehicle, and not only in a normal driving direction.

Optionally, the step (S2) of determining that the accident situation has occurred between the at least two vehicles (B, C) may further comprise: determining, by using said received data, that the accident situation has occurred between the at least two vehicles (B, C) when also a deceleration to standstill of at least one of the at least two vehicles has occurred. Thereby, an even further improved identification of the accident situation may be provided by also determining when at least one of the at least two vehicles has been brought to standstill, i.e. has stopped.

Optionally, the method may be performed by a control unit in a further vehicle different from the at least two vehicles which are part of the accident situation. It has been found that it would be beneficial to perform the method in a further vehicle not being part of the accident situation. For example, the at least two vehicles involved in the accident situation may not be able to inform about the accident after the accident has occurred. However, the further vehicle not being part of the accident situation may analyse the received data and also provide the result of the analysis to at least one other unit, such as other vehicles and a back office central. Thereby, by using the received data, i.e. data comprising speed and/or acceleration and geographical position, the further vehicle may be able to initiate countermeasures and/or forwarding the information about the accident situation to any other unit which may make use of the forwarded information. By the above example, improved reliability may be provided.

Optionally, the method may further comprise the step of:
transmitting an information signal comprising information that the accident situation has occurred, wherein the information signal can be received by at least one receiver.

Preferably, the information signal may be transmitted wirelessly. Optionally, the information signal comprising information that the accident situation has occurred may be transmitted by a vehicle-to-everything (V2X) communication system. Still optionally, the transmitted information signal may further comprise information about the geographical position of the accident situation. Information relating to the geographical position of at least one of the at least two vehicles may be used as the geographical position of the accident situation. An even further increased awareness may therefore be provided by also knowing where the accident situation has occurred. Still further, safety may also be further increased by knowing the position of the accident situation. For example, an ambulance, emergency squad, maintenance/repair squad or the like, may receive information of where the accident situation has occurred to thereby being able to quickly find and arrive at the correct place.

Optionally, the received data may further comprise information indicative of at least one of the at least two vehicles' characteristics. Still optionally, the information indicative of at least one of the at least two vehicles' characteristics may comprise information about at least one of vehicle weight, type and size of the at least one of the at least two vehicles. Such information may also be used for improving understanding of the circumstances of the accident situation. For example, by knowing which type of vehicle that is involved in the accident situation, specific countermeasures may be initiated, such as requesting a similar vehicle to take over the assignment of at least one of the two vehicles which have been involved in the accident situation. This may be specifically advantageous when the vehicles are work machines, such as construction equipment on a work site. Optionally, the transmitted information signal may further comprise the information indicative of at least one of the at least two vehicles' characteristics.

Optionally, the at least two vehicles may be located within a confined area. It has been found that the method as disclosed herein may be specifically useful for vehicles operating in a confined area, which may be any one of a construction area, a factory area, a mining area and the like. The confined area may hence be defined as an area which is enclosed by an outer boundary, which may be a fence or the like. Alternatively, the confined area may be defined as an area where a number of work machines, such as construction equipment, are operating. Hence, the confined area may not necessarily be bounded by a fence or the like but could likewise be defined by an imaginary “fence”. One advantage of using the method in the aforementioned circumstances, i.e. within the confined area, is that the vehicles operating in the confined area may comprise similar equipment for communicating with each other. Thereby, the implementation of the method according to the present invention may be made in a cost-efficient manner for the confined area. Other advantages of using the method as disclosed herein for vehicles in a confined area is that it may improve safety and increase awareness of accident situations therein. Optionally, the transmitted information signal may be configured to be received by a back office central and/or by another vehicle located within the confined area.

According to a second aspect, the object is provided by a control unit for identifying an accident situation between at least two vehicles, the control unit being configured to perform the steps of the method according to any one of the embodiments of the first aspect of the invention. It shall be noted that all embodiments of the first aspect of the invention are applicable and combinable to any one of the embodiments of the second aspect of the invention and vice versa, unless explicitly expressed otherwise. Moreover, advantages and effects of the embodiments of the second aspect of the invention are also largely analogous to the advantages and effects of the embodiments of the first aspect of the invention and vice versa. It has namely been found that providing a control unit comprising the method according to any one of the embodiments of the first aspect of the invention may result in improved safety and increased awareness about the accident situation. For performing the method according to any one of the embodiments of the present invention, the control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

According to a third aspect, the object is provided by a vehicle comprising the control unit according to any one of the embodiments of the second aspect of the invention. It shall be noted that all embodiments of the first and second aspects of the invention are applicable and combinable to any one of the embodiments of the third aspect of the invention and vice versa, unless explicitly expressed otherwise. Moreover, advantages and effects of the embodiments of the third aspect of the invention are also largely analogous to the advantages and effects of the embodiments of the first and second aspects of the invention and vice versa. It has namely been found that providing a vehicle comprising a control unit according to any one of the embodiments of the second aspect of the invention may result in improved safety and increased awareness about the accident situation.

Optionally, the vehicle may be any one of a truck and a working machine, such as a wheel loader, an articulated hauler, an excavator, a backhoe loader, a compactor and a paver. Still optionally, the vehicle may also be a car, such as a passenger car and a passenger road car.

Optionally, the vehicle may further comprise a display for a user of the vehicle for displaying information relating to the accident situation. Thereby, the user of the vehicle may receive information which may be used for e.g. avoiding the area where the collision has occurred, for driving to the collision location to assist the other vehicles, or for any other suitable purpose. For example, a road, a road passage or the like, may due to the accident situation be blocked, or at least provide reduced accessibility, for a vehicle not being part of the accident situation. Thereby, user(s) of the other vehicle(s) may by the provided information in the display select another road path to avoid the location with the reduced accessibility where the accident situation has occurred. Alternatively, or additionally, the vehicle may comprise means for providing an alternative road path for the user of the vehicle based on the information about the accident situation. According to a fourth aspect, the object is provided by a computer program comprising program code means for performing the method steps of any of the embodiment of the first aspect of the invention when said program is run on a computer.

According to a fifth aspect, the object is provided by a computer readable medium carrying a computer program comprising program code means for performing the method steps of any of the embodiments of the first aspect of the invention when said program product is run on a computer.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is shows a flowchart of an example embodiment of the method according to the present invention,

FIG. 2 is shows a schematic illustration of a confined area with a vehicle according to an embodiment of the present invention, and

FIG. 3 is shows a schematic and more detailed view of how a control unit according to an embodiment of the present invention may be communicating with other units.

The drawings show diagrammatic exemplifying embodiments of the present invention and are thus not necessarily drawn to scale. It shall be understood that the embodiments shown and described are exemplifying and that the invention is not limited to these embodiments. It shall also be noted that some details in the drawings may be exaggerated in order to better describe and illustrate the invention. Like reference characters refer to like elements throughout the description, unless expressed otherwise.

### DETAILED DESCRIPTION OF EXAMPLE EMBODIMENTS OF THE INVENTION

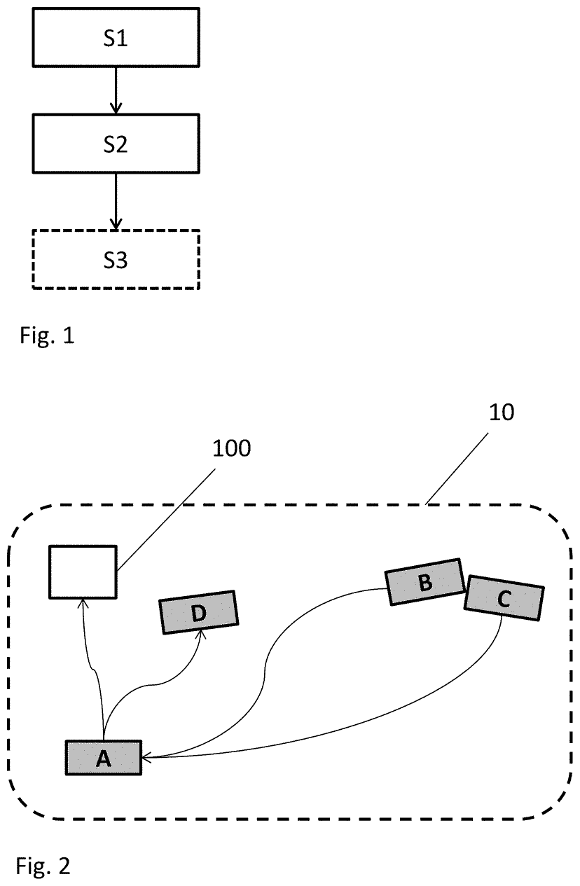

FIG. 1 depicts a flowchart of an example embodiment of the method according to the first aspect of the present invention. The method comprises the steps S1-S3, where the step S3 is optional, indicated by a box enclosed with dashed lines. The flowchart depicts a method for identifying an accident situation between at least two vehicles, B and C, see FIG. 2, wherein the method comprises the steps of:
S1, receiving data relating to the at least two vehicles, B and C, which data comprises information indicative of geographical position and at least one of velocity and acceleration of each one of the at least two vehicles, B and C;
S2, determining, by using the received data, that the accident situation has occurred between the at least two vehicles, B and C, when a deceleration of at least one, B and/or C, of the at least two vehicles, B and C, exceeds a predetermined threshold value at the substantially same point in time at which the at least two vehicles, B and C, are located at the substantially same geographical position. Purely by way of example, a deceleration value, i.e. the predetermined threshold value, used for identifying the accident situation may be any one of 3, 4, 5, 6, 7, 8 m/s² or higher. It shall be noted that the deceleration value may be an absolute value.

For example, and preferably, each one of the vehicles, B and C, comprises means for determining geographical position, such as GPS or the like, and also monitoring means, such as sensors, for monitoring at least one of speed and acceleration. The monitoring may be performed continuously or intermittently, depending on the circumstances. As would be well understood, speed and/or acceleration may be measured and identified by different means, such as speed sensors at the vehicle's wheels for measuring speed, accelerometers for measuring acceleration etc., but could also be measured and identified by other means, such as tracking change of the vehicle's geographical position over time by the use of a GPS system, and therefrom calculate a change in speed and/or acceleration. Alternatively, and purely by way of example, speed and/or acceleration may also be identified by camera monitoring of the at least two vehicles, where the speed and/or acceleration may be determined and estimated by image processing. Similarly, and purely by way of example, geographical position may also be identified and estimated by a camera monitoring system. However, providing sensors for measuring speed and/or acceleration and a geographical positioning system on each vehicle has shown to result in a robust and cost-efficient system for performing the method according to the present invention.

The received data in step S1 from the at least two vehicles B and C may be received continuously or intermittently, depending on the needs and on the circumstances.

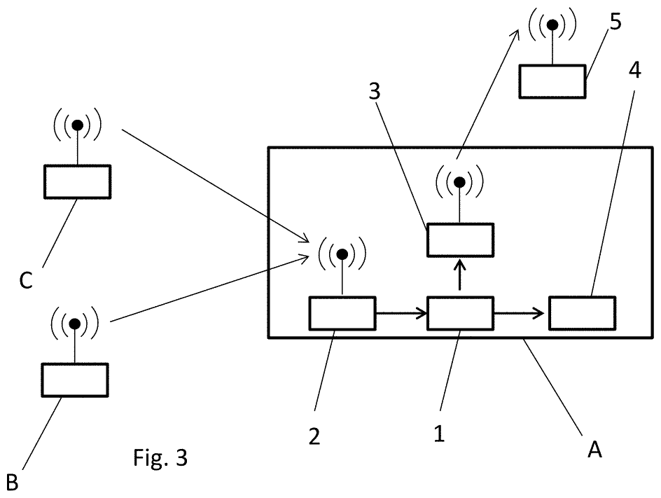

The method in FIG. 1 further comprises the step S3 of:
transmitting an information signal comprising information that the accident situation has occurred, wherein the information signal can be received by at least one receiver 5, see FIG. 3.

The information signal may be transmitted by a wireless communication system, such as V2X as mentioned hereinabove. Evidently, the received data in step S1 may be received wirelessly, i.e. wirelessly receiving at least one data signal which comprises information indicative of geographical position and at least one of velocity and acceleration of each one of the at least two vehicles, B and C.

FIG. 2 schematically depicts a confined area 10, represented by a dashed line, where a vehicle A according to an embodiment of the present invention operates. FIG. 3 depicts a schematic illustration of vehicle A, vehicle B, vehicle C and a receiver 5 located remotely from vehicle A. The confined area 10 may for example be a construction area and the vehicles A, B, C and D may be working machines, e.g. construction equipment, such as articulated haulers, excavators etc. In this embodiment, vehicle A comprises a control unit 1, see FIG. 3, for performing the steps according to an example embodiment of the first aspect of the present invention. Vehicle B and vehicle C may comprise means for monitoring its respective speed and/or acceleration, and geographical position. The data generated in each respective vehicle, by e.g. respective control units in each respective vehicle B and C, may then be transmitted, via e.g. wireless V2X communication means, to vehicle A. Vehicle A may then comprise a receiver 2, see FIG. 3, which receives the data from vehicles B and C. The control unit 1 is then configured to perform the steps of the method as disclosed herein. When it is determined that an accident situation has occurred between vehicles B and C, by processing the received data, the information about the accident situation may be transmitted, also e.g. by a wireless V2X communication means, from the control unit 1 and via a transmission device 3. The transmitted information about the accident situation may then be received by the receiver 5. The receiver 5 may be a receiver of a back office central 100, such as a back office of the construction area of the confined area 10 and/or it may be a receiver 5 of, e.g. another vehicle D which operates in the confined area 10. Thereby, vehicle A, which is not part of the accident situation will perform the analysis of the received data from vehicles B and C, and the result from the analysis may be transmitted for informing other units related to the confined area 10. Hence, an increased awareness of the accident may be provided, and also operational safety in the confined area 10 may be improved. Moreover, in the embodiment of FIG. 3, vehicle A comprises a display 4 for providing a warning or a notification to an operator of the vehicle. As already stated hereinabove, the display 4 may also be used for providing an alternative road path based on the information about the accident situation.

All of the vehicles as presented herein may be provided as autonomous or at least semi-autonomous vehicles. Hence, the method according to any one of the embodiments of the present invention may advantageously be implemented in a control unit of an autonomous or semi-autonomous vehicle. It has been found that providing the method of the present invention in control units of autonomous or semi-autonomous vehicles in a confined area may be especially advantageous for efficiently controlling the operation of the vehicles.

It is to be understood that the present invention is not limited to the embodiments described above and illustrated in the drawings; rather, the skilled person will recognize that many changes and modifications may be made within the scope of the appended claims.

1. A method for identifying an accident situation between at least two vehicles, characterized by the steps of:
receiving data relating to the at least two vehicles, which data comprises information indicative of geographical position and at least one of velocity and acceleration of each one of the at least two vehicles; and
determining, by using said received data, that the accident situation has occurred between the at least two vehicles when a deceleration of at least one of the at least two vehicles exceeds a predetermined threshold value at the substantially same point in time at which the at least two vehicles are located at the substantially same geographical position.

2. The method according to claim 1, wherein the step of determining that the accident situation has occurred between the at least two vehicles comprises, determining, by using said received data, that the accident situation has occurred between the at least two vehicles when a deceleration of each one of the at least two vehicles exceeds a predetermined threshold value at the substantially same point in time at which the at least two vehicles are located at the substantially same geographical position.

3. The method according to claim 1, wherein the step of determining that the accident situation has occurred between the at least two vehicles further comprises:
determining, by using said received data, that the accident situation has occurred between the at least two vehicles when also a deceleration to standstill of at least one of the at least two vehicles has occurred.

4. The method according to claim 1, wherein the method is performed by a control unit in a further vehicle different from the at least two vehicles which are part of the accident situation.

5. The method according to claim 1, further comprising the step of:
transmitting an information signal comprising information that the accident situation has occurred, wherein said information signal can be received by at least one receiver.

6. The method according to claim 5, wherein the information signal comprising information that the accident situation has occurred is transmitted by a vehicle-to-everything (V2X) communication system.

7. The method according to claim 5, wherein the transmitted information signal further comprises information about the geographical position of the accident situation.

8. The method according to claim 5, wherein the received data further comprises information indicative of at least one of the at least two vehicles' characteristics.

9. The method according to claim 8, wherein the information indicative of at least one of the at least two vehicles' characteristics comprises information about at least one of vehicle weight, type and size of the at least one of the at least two vehicles.

10. The method according to claim 8, wherein the transmitted information signal further comprises the information indicative of at least one of the at least two vehicles' characteristics.

11. The method according to claim 1, wherein the at least two vehicles are located within a confined area.

12. The method according to claim 11, wherein the confined area is any one of a construction area, a factory area, a mining area and the like.

13. The method according to claim 11, wherein the transmitted information signal is configured to be received by a back office central and/or by another vehicle located within the confined area.

14. A control unit for identifying an accident situation between at least two vehicles, the control unit being configured to perform the steps of the method according to claim 1.

15. A vehicle comprising the control unit according to claim 14.

16. The vehicle according to claim 15, wherein the vehicle is any one of a truck and a working machine, such as a wheel loader, an articulated hauler, an excavator, a backhoe loader, a compactor and a paver.

17. The vehicle according to claim 15, wherein the vehicle further comprises a display for a user of the vehicle for displaying information relating to the accident situation.

18. A computer program comprising program code means for performing the steps of claim 1 when said program is run on a computer.

19. A computer readable medium carrying a computer program comprising program code means for performing the steps of claim 1 when said program product is run on a computer.
